(19) United States
(12) Patent Application Publication
(10) Pub. No.: US 2022/0129933 A1
(43) Pub. Date: Apr. 28, 2022

(54) NOVEL METHOD OF ACCELERATING DYNAMIC AVAILABILITY AND PRICING IN FLEETS

(71) Applicant: Verijet Holding Company, LLC, Boca Raton, FL (US)

(72) Inventor: Richard Kane, Boca Raton, FL (US)

(73) Assignee: Verijet Holding Company, LLC, Boca Raton, FL (US)

(21) Appl. No.: 17/078,589

(22) Filed: Oct. 23, 2020

(51) Int. Cl. G06Q 30/02; G06Q 10/04; G06Q 10/10; G06N 3/08

(52) U.S. Cl. CPC G06Q 30/0206; G06N 3/082; G06Q 10/1093; G06Q 10/047

(57) ABSTRACT

The invention contemplates utilizing high speed cache architecture, flat high speed neural nets, high speed pruning of solution trees via a novel use of a technique similar to Hamming Codes normally used for error correction in noisy communications channels, GPU and AI accelerating hardware and extensive parallel processing to identify a) potential to serve a request and b) cost of serving that request including a partial re-optimization of flight routings in real time and c) not to exceed cost calculations in minimal timeframes and d) identification of impacted flights and the before/after cost of the re-optimization to drive the pricing and efficiency calculations.

### FIELD OF THE INVENTION

The present invention relates to novel methods for the speeding and securing the availability and pricing confirmations to booking portals and between trading partners.

### BACKGROUND

Using neural networks to optimize fleets of aircraft and find best routing solutions is effective but slow. This is rate limited and computationally expensive when dealing with large fleets. This invention sits between exhaustive modeling and real time availability and pricing checks. Today airlines are able to sell seats on established routes, and do not face the problem of routing and availability of aircraft—they are essentially selling inventory—and that is how airline IT systems are able to respond timely to booking portals. This inventory on a route concept is the hallmark of the scheduled airline. Charter fleets are much more dynamic, and the response to availability is not a simple inventory and demand pricing calculation—it is a complex check of crew, airplane, and geospatial calculation to be a) safe b) cost effective c) efficient and D) legal.

Therefore, a need exists in the field for novel approaches to dynamically price and manage a floating fleet responding to random travel requests in sufficient timeliness to provide real time sales.

### BRIEF SUMMARY OF THE INVENTION

The invention contemplates utilizing high speed cache architecture, flat high speed neural nets, high speed pruning of solution trees via a novel use of a technique similar to Hamming Codes (normally used for error correction in noisy communications channels), GPU and AI accelerating hardware and extensive parallel processing to identify a) potential to serve a request and b) cost of serving that request including a partial re-optimization of flight routings in real time and c) not to exceed cost calculations in minimal timeframes and d) identification of impacted flights and the before/after cost of the re-optimization to drive the pricing and efficiency calculations.

### BRIEF DESCRIPTION OF THE DRAWINGS

Some embodiments of the present invention are illustrated as an example and are not limited by the figures of the accompanying drawings, in which like references may indicate similar elements and in which:

FIG. 1—FIG. 1 depicts adjacent connectible flights, validated thru rules, and the network traffic fingerprints that define the potential connections. Using AND/OR logic against Hamming Codes representing network traffic allows a fast identification of potential routes.

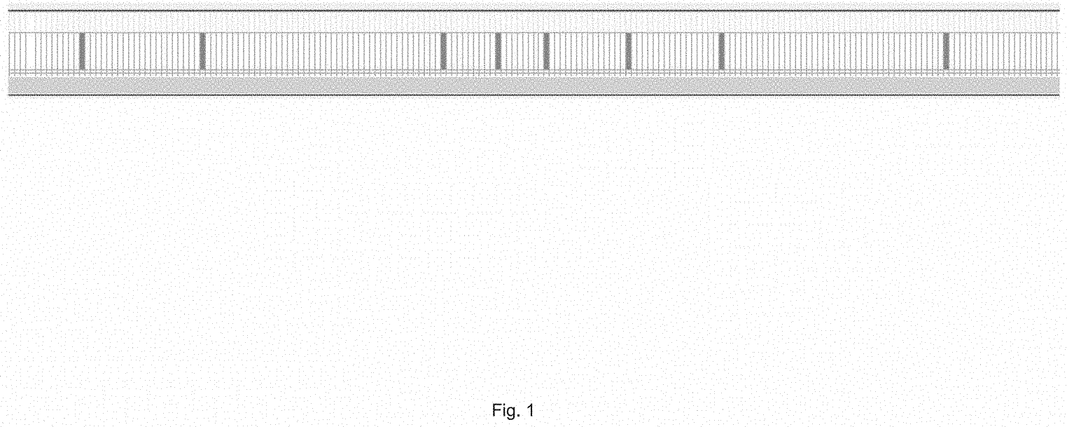

FIG. 2—FIG. 2 depicts actual cost savings over successive iterations of the genetic algorithms with pattern matching and neural nets making point improvements between successive models.

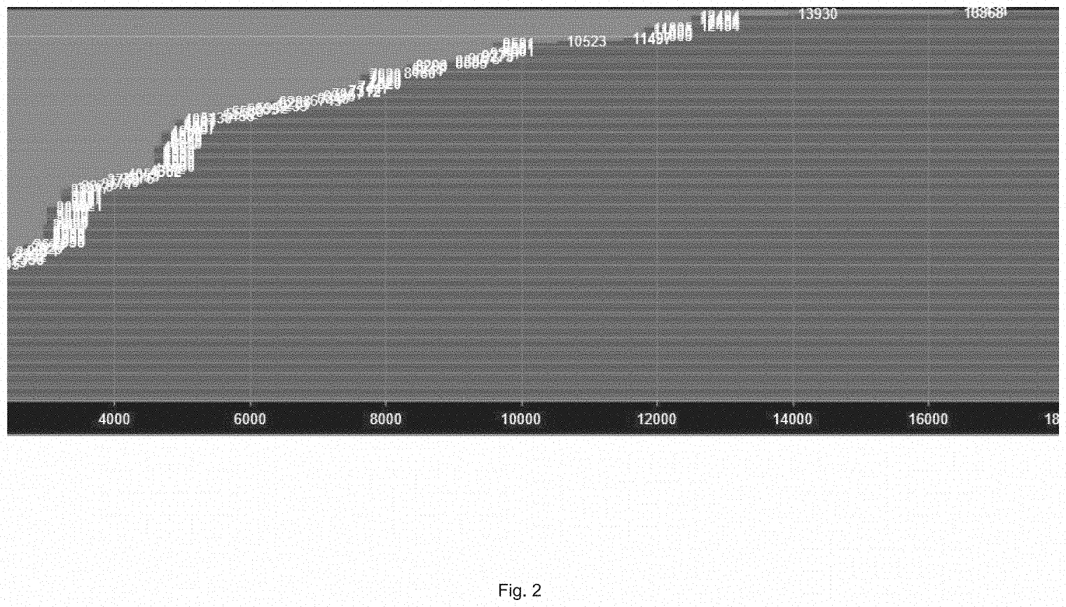

FIG. 3—FIG. 3 Shown are the A and B locations of each flight request being analyzed. In this case a Stuart, FL-Atlanta, Ga. trip is fit inside a reposition for maintenance from PBI to the maintenance base at TYS. The combination of patterns is unique on any transportation network at any location, based on the exponentially growing number of potential routings. Some of these patterns will improve efficiency, others degrade efficiency. In this case it is wildly efficient to accept this booking as it reduces 436 NM of actual cost (the reposition for MX to TYS), moving that cost to revenue.

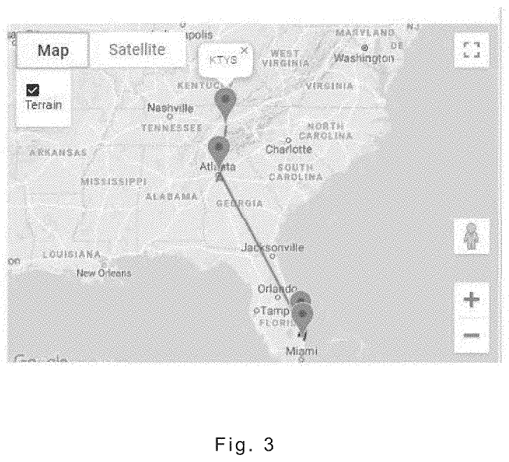

### DETAILED DESCRIPTION OF THE INVENTION

The invention measures the interconnectedness fabric at the route being flown and uses that information to subset the universe of aircraft re-routings to be matched.

The holographic map of this data uniquely identifies a routing pattern within the physical world, within the new routing request evolving that map. This map can be leveraged to calculate a before and after cost. This map can be leveraged for efficiency calculations. This map can be leveraged to identify a specific location in time and space communicating availability capacity and the cost of that capacity.

Although the present invention has been illustrated and described herein with reference to preferred embodiments and specific examples thereof, it will be readily apparent to those of ordinary skill in the art that other embodiments and examples may perform similar functions and/or achieve like results. All such equivalent embodiments and examples are within the spirit and scope of the present invention, are contemplated thereby, and are intended to be covered by the following claims.

1. A method of augmenting the speed of availability checks with dynamic pricing comprising utilizing high speed cache architecture, flat high speed neural nets, high speed pruning of solution trees via a novel use of a technique similar to Hamming Codes, GPU and AI accelerating hardware and extensive parallel processing to provide outputs that identify a) potential to serve a request and b) cost of serving that request including a partial re-optimization of flight routings in real time and c) not to exceed cost calculations in minimal timeframes and d) identification of impacted flights and the before/after cost of the re-optimization to drive the pricing and efficiency calculations.

2. A method as in claim 1 including geometrically speeding up availability checks by the use of holographic mapping of one or more of the identified outputs a-d listed in claim 1.

3. A method as in claim 2 including increasing efficiency by aggressively pricing optimum flights.

4. A method as in claim 3 that includes pre-fetch of price data based on pre-calculated metrics.

5. A method as in claim 1 including the use of Hamming Codes to enumerate every legal set of flights to interconnect and overall potential flight dispatches.

6. A method as in claim 5 including the use of Hamming Codes to speed pruning of a solution set to legal and efficient flights to interconnect.

7. A method as in claim 5 including pre-fetching of likely next scenarios, based on time of day, day of week, and other detailed pattern analysis of travel schedules on fleet and off-fleet.

8. A method as in claim 7 including using pre-calculated zones to generalize likely next scenarios.

9. A method as in claim 1 including using an acceleration layer to speed up queries against an existing AI
